(19) United States
(12) Patent Application Publication
(10) Pub. No.: US 2017/0213147 A1
(43) Pub. Date: Jul. 27, 2017

(54) GENERATING DESCRIPTION TEXT FOR APPLICATIONS

(71) Applicant: International Business Machines Corporation, Armonk, NY (US)

(72) Inventors: Senthil Kumar Kumarasamy Mani, Bangalore (IN); Giriprasad Sridhara, Bangalore (IN)

(21) Appl. No.: 15/006,631

(22) Filed: Jan. 26, 2016

(51) Int. Cl. G06N 99/00; G06F 17/30

(52) U.S. Cl. CPC G06N 99/005; G06F 17/30675

(57) ABSTRACT

One embodiment provides a method for generating description text for a desired application using a machine classifier trained using other applications, the method including: utilizing at least one processor to execute computer code that performs the steps of: obtaining description text and at least one application component for an application; identifying at least one application characteristic from the at least one application component; associating at least one word expression contained within the description text to at least one identified application characteristic; training the machine classifier, wherein the training comprises identifying similar application characteristics within the at least one application component and identifying, based upon the associating, a condition of the at least one application characteristic including the at least one word expression; obtaining at least one application component for the desired application; identifying, using the trained machine classifier, at least one application characteristic of the desired application for use in generating description text for the desired application; and generating description text for the desired application using the at least one identified application characteristic of the desired application. Other aspects are described and claimed.

### BACKGROUND

When purchasing or reviewing an application (e.g., mobile device application, game, software program, etc.) a user may be presented with different information about the application to assist the user in determining whether the application will be useful to the user. For example, some applications may include an average rating which may be provided by prior users, number of downloads, screen shots of different parts of the application, reviews by other users, a short text description, and the like.

Many users find the description for the application to be a very useful tool in making a determination regarding the application. The description typically includes the features (or functionality) of the application. Additionally, some descriptions may include text describing new features or functions of a new version of an application versus an old version of the application. Many users prefer succinct descriptions as opposed to verbose descriptions. However, a user still wants to be presented with all the important information regarding the application. Generally, writing the description for the application is the responsibility of the developer of the application. However, the developer of the application may be more interested in the development of the application, rather than spending time trying to write a succinct description including all the important information.

### BRIEF SUMMARY

In summary, one aspect of the invention provides a method for generating description text for a desired application using a machine classifier trained using other applications, the method comprising: utilizing at least one processor to execute computer code that performs the steps of: obtaining description text and at least one application component for an application; identifying at least one application characteristic from the at least one application component; associating at least one word expression contained within the description text to at least one identified application characteristic; training the machine classifier, wherein the training comprises identifying similar application characteristics within the at least one application component and identifying, based upon the associating, a condition of the at least one application characteristic including the at least one word expression; obtaining at least one application component for the desired application; identifying, using the trained machine classifier, at least one application characteristic of the desired application for use in generating description text for the desired application; and generating description text for the desired application using the at least one identified application characteristic of the desired application.

Another aspect of the invention provides an apparatus for generating description text for a desired application using a machine classifier trained using other applications, the apparatus comprising: at least one processor; and a computer readable storage medium having computer readable program code embodied therewith and executable by the at least one processor, the computer readable program code comprising: computer readable program code that obtains description text and at least one application component for an application; computer readable program code that identifies at least one application characteristic from the at least one application component; computer readable program code that associates at least one word expression contained within the description text to at least one identified application characteristic; computer readable program code that trains the machine classifier, wherein the training comprises identifying similar application characteristics within the at least one application component and identifying, based upon the associating, a condition of the at least one application characteristic including the at least one word expression; computer readable program code that obtains at least one application component for the desired application; computer readable program code that identifies, using the trained machine classifier, at least one application characteristic of the desired application for use in generating description text for the desired application; and computer readable program code that generates description text for the desired application using the at least one identified application characteristic of the desired application.

An additional aspect of the invention provides a computer program product for generating description text for a desired application using a machine classifier trained using other applications, the computer program product comprising: a computer readable storage medium having computer readable program code embodied therewith, the computer readable program code comprising: computer readable program code that obtains description text and at least one application component for an application; computer readable program code that identifies at least one application characteristic from the at least one application component; computer readable program code that associates at least one word expression contained within the description text to at least one identified application characteristic; computer readable program code that trains the machine classifier, wherein the training comprises identifying similar application characteristics within the at least one application component and identifying, based upon the associating, a condition of the at least one application characteristic including the at least one word expression; computer readable program code that obtains at least one application component for the desired application; computer readable program code that identifies, using the trained machine classifier, at least one application characteristic of the desired application for use in generating description text for the desired application; and computer readable program code that generates description text for the desired application using the at least one identified application characteristic of the desired application.

A further aspect of the invention provides a method for generating description text for a desired application using a machine classifier trained using other applications, the method comprising: utilizing at least one processor to execute computer code that performs the steps of: obtaining description text and source code for an application; identifying at least one code characteristic contained within the source code; associating at least one word expression contained within the description text to at least one identified code characteristic; identifying, by running the application, at least one screen encountered within the application; associating at least one word expression contained within the description text to at least one screen; training the machine classifier, wherein the training comprises identifying similar code characteristics within the source code and identifying, based upon the associating, a condition of the at least one code characteristic including the at least one code characteristic associated word expression and the at least one screen including the at least one screen associated word expression; obtaining source code for the desired application; identifying, by running the desired application, at least one screen encountered within the desired application; identifying, using the trained machine classifier, at least one code characteristic contained within the source code of the desired application and at least one screen of the desired application for use in generating description text for the desired application; and generating description text for the desired application using the at least one identified code characteristic and the at least one identified screen of the desired application.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of generating description text for applications.

FIG. 2 illustrates an example application having description text.

FIG. 3 illustrates an example dataset for training a machine classifier.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

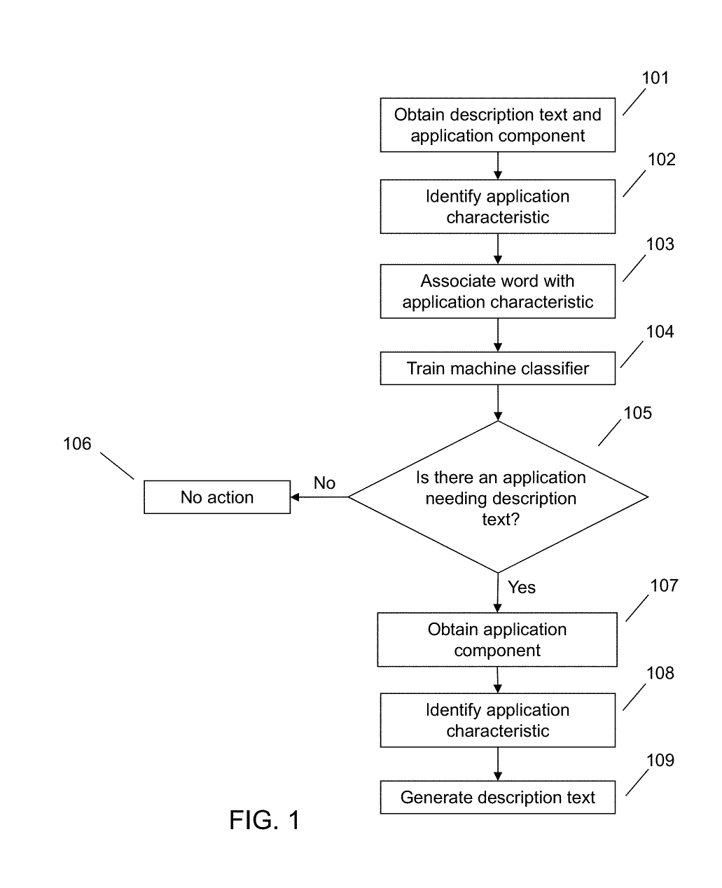

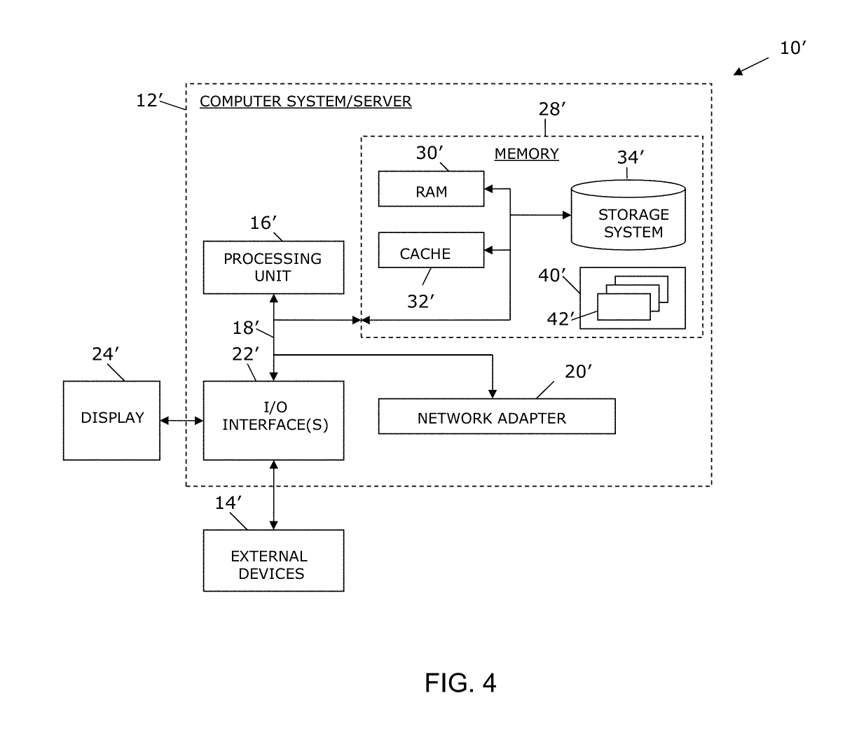

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

Users find descriptions regarding the features and functions of an application (e.g., mobile application, game, computer program, software, etc.) to be useful in deciding whether to use (e.g., purchase, download, play, etc.) the application. In many cases the job of writing the description is left to the developer of the application, who may prefer to spend more time on developing the application rather than writing a description. Typically, users do not have the patience to read verbose descriptions, however, the description should be long enough to convey the interesting features of the application to a user, so that the application appeals to a user and also so that a user can make an informed decision regarding the application. If a new version of an application has been created, a user may want to know the new features of the application. However, in conveying this information, users prefer a succinct description and may get frustrated with long verbose descriptions. A developer or other description writer may find it difficult to provide enough information about the interesting features of the application while keeping the description short and concise.

Accordingly, an embodiment provides a method of generating description text for a desired application using a machine classifier trained using other applications. The system may access an application component (e.g., source code, application screens, activities, etc.) of existing applications that have description text already written. After obtaining the application component an embodiment may identify at least one application characteristic from the application component. The application characteristic may include entities (e.g., class, module, method name, method call site name, comments, screens, etc.) related to the application component. An embodiment may associate a word or phrase contained within the description text to the application characteristic to identify which application characteristics lend to the description text.

Using this information a machine learning classifier (“machine classifier”) may be trained. The machine classifier may identify similar application characteristics (e.g., all the classes, all the activities, etc.) and identify a condition of the application characteristic including the word of the description. Once the machine classifier is trained, an embodiment may obtain an application component for an application in which description text needs to be generated. Using the machine classifier, an embodiment may identify an application characteristic that should be used in generating the description text. In one embodiment, the application characteristic may include differences between a new and older version of an application. An embodiment may then generate description text for the desired application based upon the application characteristic. In one embodiment, generating the description text may include suggesting text (e.g., words, phrases, sentences, etc.) as opposed to creating the whole description text. As an overall example, an embodiment may use source code from known applications to train a machine classifier on what application characteristics should be included in the description text. Using the machine classifier, an embodiment may generate description text for a new application using the source code from the desired application.

Such a system provides a technical improvement over current systems for generating description text for an application in that the generation of the description text can be partially or wholly automated as opposed to the entirely manual methods known in the art. The systems and methods described herein provide a user with suggestions or wholly generated description text, allowing an application developer to focus on developing the application rather than writing a description for the application. The system provides a method for generating description text that includes the important features and functions of the application without input from the developer. Additionally, the system provides a method for revising description text between versions of an application, which may include removing text that is no longer applicable to the application. The system also improves testing efficiency because tests can be designed to test for important features that are mentioned in the generated description text. Thus, the systems and methods described herein provide an efficient and useful system for generating description text for a desired application.

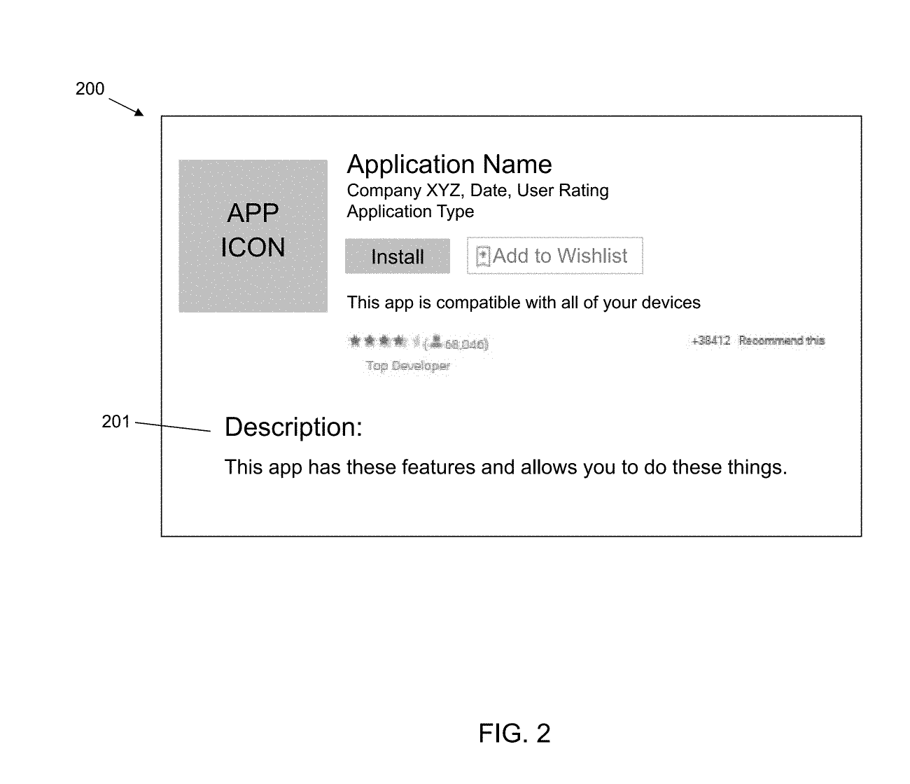

Referring now to FIG. 1, an embodiment may obtain description text and at least one application component for an application at 101. The description text and application component obtained may be for one or more applications in which the description text has already been written or provided. For example, referring to FIG. 2, a page for an application 200 may include description text 201 that may be obtained by an embodiment. In obtaining the description text, an embodiment may receive the page that includes the description text and parse the description text. As another example, an embodiment may access the code for the page and retrieve the description text from within the code. Alternatively, a user may manually enter the description text into the system.

The application(s) chosen for obtaining the description text may include applications which have good description text. For example, training the machine classifier using applications having bad, inaccurate, or missing description text will result in a machine classifier which provides or generates description text that is bad, inaccurate, or missing description text. To determine which applications have good description text, the applications may be chosen automatically by the system or designated manually by a person. For example, a user may manually designate an application as having good description text. As another example, the system may be programmed with criteria against which the system can compare the description text. Using the criteria the system can then determine which applications have good description text and use these applications for training the machine classifier, as discussed in further detail below.

In one embodiment the application component may include the source code for the application. For example, if an application is open source, meaning the source code is publically accessible, an embodiment may be able to obtain the source code. The application component may also include application screens or pages. For example, an application screen may be a screen that is encountered during execution of the application. In executing the application an embodiment may explore the application on an emulator. Exploring may include automatically starting the application and then automatically performing user actions on elements (e.g., buttons, text entry points, radial buttons, etc.) within the application. In obtaining the application screens, an embodiment may execute/explore the application and identify different screens that are encountered during execution/exploration of the application. One embodiment may access more than one application component. For example, an embodiment may access both the source code and additionally execute the program and identify different screens encountered during execution. Other application components are possible and contemplated.

At 102 an embodiment may identify at least one application characteristic from the application component(s). The application characteristic may include entities related to the application component. For example, if the application component includes the source code, an application characteristic may include a code characteristic or entity (e.g., class, module, method name, object, method call site name, comments, etc.) of the source code. In addition, an embodiment may identify additional application characteristics related to the code entity, for example, how many lines of code are included in a single entity, the number of revisions of the code, how many entities are included in the code, and the like. If the application component includes the screens encountered during execution, an embodiment may identify application characteristics related to the screens encountered. For example, an embodiment may identify each screen as an activity and identify activity characteristics, (e.g., how many activities lead to a particular activity, how many geodesics passing on which an activity lies, etc.). Additional application characteristics may be identified related to the screens, for example, the title associated with the screen, text included on the screen, and the like.

At 103, an embodiment may associate at least one word expression contained within the description text to at least one of the identified application characteristics. The word expression may include a word or it may include a phrase or an entire sentence. For example, an embodiment may map the words contained within the description text to an application characteristic. As an example, if the description text includes the word “Reader” an embodiment may identify which application characteristic(s) include the word “Reader”. For example, an embodiment may identify that a class name includes the word “Reader”. This class and the word “Reader” would then be associated. As another example, an embodiment may identify that the second screen encountered includes the word “Reader”. This screen/activity may then be associated with the word “Reader”.

Using the information gathered in steps 101, 102, and 103, an embodiment may train a machine learning classifier (“machine classifier”) at 104. Generally training the machine classifier would be an iterative process completed with more than a single application. However, the machine classifier can be trained with just a single application, but the results may not be very good. However, typically the machine classifier will be trained with more than one application. The machine classifier may be a DecisionTree, Support Vector Machine, or other type of machine learning classifier. The machine classifier is used to predict conditions in which an application characteristic should be used in the description text. In training the machine classifier, an embodiment may identify similar application characteristics within the application component. For example, an embodiment may identify all the classes within the source code, all the screens/activities encountered during execution of the application, all the modules within the source code, and the like. In other words, an embodiment may group similar application characteristics.

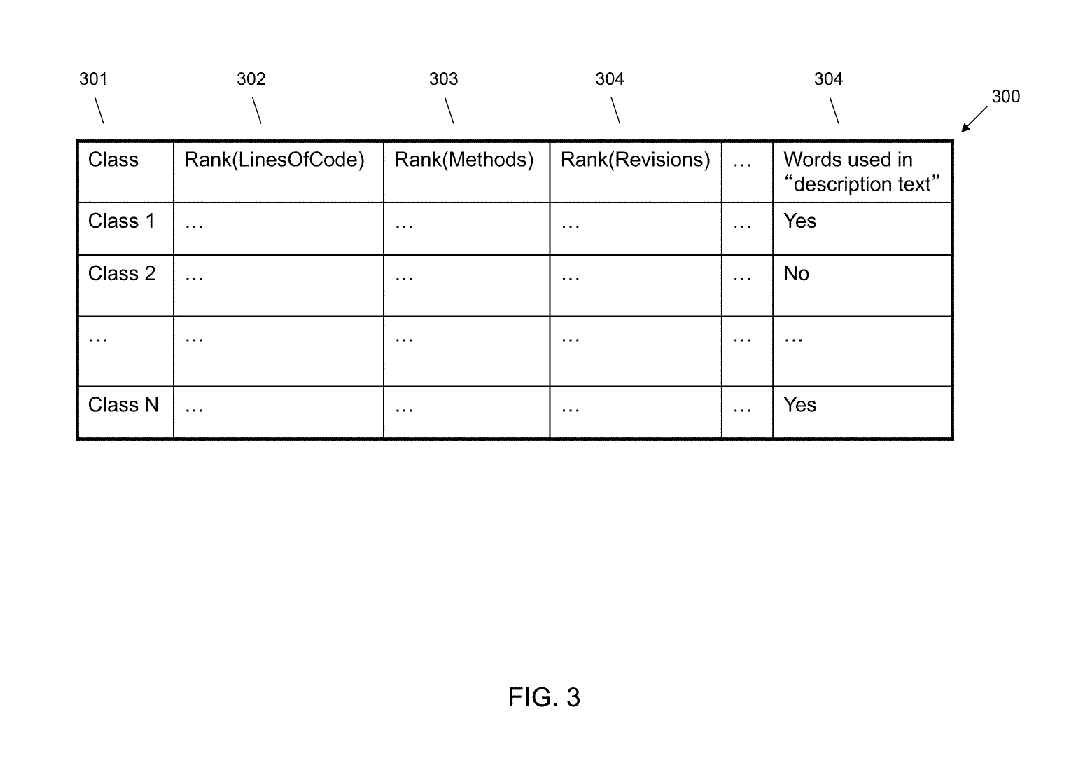

In one embodiment the similar application characteristics may be ranked based upon a predetermined criterion. For example, referring to FIG. 3, an embodiment may create a data set 300 for training the machine classifier. In the example where classes having similar application characteristics are grouped, an embodiment may identify all the classes 301 contained within the source code of the application. In the example, the classes are numbered, but in practice each class may have a name associated with it (e.g., class Reader). An embodiment may then rank the classes based upon a predetermined criterion. For example, the classes may be ranked by the number of lines of code 302 that are included in each class. Additionally, the classes may be ranked by the methods 303 in the class and the number of revisions 304 of each class. A ranking may not necessarily be a ranking in the specific sense, but rather may include a position of a class when all the classes are sorted in order by one of the criteria. Additional criteria for ranking the application characteristics are possible and contemplated.

Training the machine classifier may additionally include identifying a condition of the application characteristic that includes the word expression 304. For example, in one embodiment, where the classes are not ranked, an embodiment may identify a condition that leads to an application characteristic being used in the description text. For example, an embodiment may identify that the name of the module that comes first in the source code is usually used in the description text. An embodiment may then create a rule based upon the identified condition. For example, an embodiment may create a rule that the name of the module occurring first in the source code should be used in the description text.

In an embodiment where the grouped similar characteristics are ranked, the condition of the application characteristic may be based upon the ranking. As an example, if the classes have been ranked by the number of lines of code contained within each class, an embodiment may determine whether a word contained within the description is related to each class. Based upon this, an embodiment may identify a condition for the word appearing within the description. For example, an embodiment may identify that for the classes ranked first through fifth in lines of code, the class name is generally included in the description. Thus, the condition may be that if the class ranks between the first and fifth in lines of code, then the class name is included in the description text. In identifying a condition or creating a rule, the condition or rule does not have to occur all the time. For example, in using more than one application, an embodiment may identify that object names of objects having more than three revisions are included in the description text 85% of the time. A rule may then be created in which object names of objects having more than three revisions should be included in the description text. In other words, in identifying a condition and creating a rule, the amount may only need to be above a predetermined threshold rather than all the time.

Another example embodiment may use the screens encountered during execution of the application. An embodiment may create a graph of the screens or activities encountered during execution. This graph may indicate which screens lead to other screens, how many screens will lead to a particular screen, how many screens can be encountered from a single screen, the number of geodesics passing on which a screen lies, and the like. From the graph an embodiment may extract network centrality measures, for example, in degree (i.e., number of edges into a vertex), out degree (i.e., number of edges from a vertex), “betweenness” centrality (i.e., the number of geodesics passing where a vertex lies), and the like. Using this information, a data set may be created similar to the data set in FIG. 3. The screens may then be sorted by the network centrality measures, and conditions may be identified. As above, an embodiment may then create a rule based upon the condition identified. The machine classifier may continually or iteratively be trained based upon new applications or information.

Once the machine classifier has been trained, an embodiment may identify whether an application needing description text generated has been obtained at 105. If a new or desired application has not been identified or obtained, an embodiment may take no action at 106. If, however, an application needing description text generated has been obtained or identified at 105, an embodiment may obtain an application component related to the desired application at 107. The application component may be one of the application components as described above (e.g., source code, screens encountered during execution, etc.) for the desired application.

At 108, an embodiment may identify, using the trained machine classifier, at least one application characteristic to be used in generating the description text for the new application. In one embodiment, identifying the application characteristic may include identifying the application characteristic(s) that satisfy a rule created. For example, using one of the rules discussed above, an embodiment may rank the classes and identify which class names should be used in the description text based upon the lines of code within the classes being ranked first through fifth. As another example, an embodiment may identify the module that occurs first in the source code and identify this module name as likely being included in the description text.

In one embodiment, the application component received may be two versions of source code for the same application. For example, an embodiment may receive version one of the source code and version three of the source code. In identifying the application characteristic, an embodiment may identify the differences or changes between the two source code versions.

At 109, an embodiment may generate the description text for the new application based upon the identified application characteristic(s). In one embodiment, generating description text may include wholly generating the description text. In one embodiment, generating description text may include revising the description text of the application. For example, if the application already has description text, an embodiment may identify words that should be deleted, added, or modified. As one example, in an embodiment where the changes between versions were identified, generating the description text may include identifying the changes between the versions. For example, this information may be included in a “What's New” section of the application page. Generating description text may also include only suggesting text rather than creating the whole text. Suggesting may also include suggestions of single words rather than whole sentences. In other words, a user may approve of the words included in the description text. Thus, an embodiment provides a method of generating description text for an application using a machine classifier trained using other applications.

The systems and methods as described herein and in connection with FIGS. 1-3 may be carried out on an information handling device (e.g., smart phone, smart TV, laptop computer, personal computer, etc.). For example, the systems and methods as described herein may be carried out on a computing system as shown in FIG. 4.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for generating description text for a desired application using a machine classifier trained using other applications, the method comprising:
utilizing at least one processor to execute computer code that performs the steps of:
obtaining description text and at least one application component for an application;
identifying at least one application characteristic from the at least one application component;
associating at least one word expression contained within the description text to at least one identified application characteristic;
training the machine classifier, wherein the training comprises identifying similar application characteristics within the at least one application component and identifying, based upon the associating, a condition of the at least one application characteristic including the at least one word expression;
obtaining at least one application component for the desired application;
identifying, using the trained machine classifier, at least one application characteristic of the desired application for use in generating description text for the desired application; and
generating description text for the desired application using the at least one identified application characteristic of the desired application.

2. The method of claim 1, wherein the training comprises ranking the similar application characteristics based upon at least one predetermined criterion.

3. The method of claim 2, wherein the condition of the at least one application characteristic is based on the ranking.

4. The method of claim 1, wherein the training comprises creating a rule based upon the condition of the at least one application characteristic including the at least one word expression.

5. The method of claim 4, wherein the identifying at least one application characteristic of the desired application comprises identifying at least one application characteristic of the desired application that satisfies the rule.

6. The method of claim 1, wherein the at least one application component comprises source code of the application and wherein the identifying at least one application characteristic comprises identifying at least one code characteristic contained within the source code.

7. The method of claim 1, wherein the at least one application component comprises at least one screen encountered within the application and wherein the identifying at least one application characteristic comprises identifying at least one activity characteristic contained within the source code.

8. The method of claim 1, wherein the generating comprises revising description text of the desired application.

9. The method of claim 1, wherein the at least one application component for the desired application comprises source code of the desired application and wherein the identifying at least one application characteristic for the desired application comprises identifying changes between an old version of the source code for the desired application and a new version of the source code for the desired application.

10. The method of claim 1, wherein the generating comprises suggesting description text.

11. An apparatus for generating description text for a desired application using a machine classifier trained using other applications, the apparatus comprising:
at least one processor; and
a computer readable storage medium having computer readable program code embodied therewith and executable by the at least one processor, the computer readable program code comprising:
computer readable program code that obtains description text and at least one application component for an application;
computer readable program code that identifies at least one application characteristic from the at least one application component;
computer readable program code that associates at least one word expression contained within the description text to at least one identified application characteristic;
computer readable program code that trains the machine classifier, wherein the training comprises identifying similar application characteristics within the at least one application component and identifying, based upon the associating, a condition of the at least one application characteristic including the at least one word expression;
computer readable program code that obtains at least one application component for the desired application;
computer readable program code that identifies, using the trained machine classifier, at least one application characteristic of the desired application for use in generating description text for the desired application; and
computer readable program code that generates description text for the desired application using the at least one identified application characteristic of the desired application.

12. A computer program product for generating description text for a desired application using a machine classifier trained using other applications, the computer program product comprising:
a computer readable storage medium having computer readable program code embodied therewith, the computer readable program code comprising:
computer readable program code that obtains description text and at least one application component for an application;
computer readable program code that identifies at least one application characteristic from the at least one application component;
computer readable program code that associates at least one word expression contained within the description text to at least one identified application characteristic;
computer readable program code that trains the machine classifier, wherein the training comprises identifying similar application characteristics within the at least one application component and identifying, based upon the associating, a condition of the at least one application characteristic including the at least one word expression;
computer readable program code that obtains at least one application component for the desired application;
computer readable program code that identifies, using the trained machine classifier, at least one application characteristic of the desired application for use in generating description text for the desired application; and
computer readable program code that generates description text for the desired application using the at least one identified application characteristic of the desired application.

13. The computer program product of claim 12, wherein the training comprises ranking the similar application characteristics based upon at least one predetermined criterion, and wherein the condition of the at least one application characteristic is based on the ranking.

14. The computer program product of claim 12, wherein the training comprises creating a rule based upon the condition of the at least one application characteristic including the at least one word expression.

15. The computer program product of claim 14, wherein the identifying at least one application characteristic of the desired application comprises identifying at least one application characteristic of the desired application that satisfies the rule.

16. The computer program product of claim 12, wherein the at least one application component comprises source code of the application and wherein the identifying at least one application characteristic comprises identifying at least one code characteristic contained within the source code.

17. The computer program product of claim 12, wherein the at least one application component comprises at least one screen encountered within the application and wherein the identifying at least one application characteristic comprises identifying at least one activity characteristic contained within the source code.

18. The computer program product of claim 12, wherein the generating comprises revising description text of the desired application.

19. The computer program product of claim 12, wherein the at least one application component for the desired application comprises source code of the desired application and wherein the identifying at least one application characteristic for the desired application comprises identifying changes between an old version of the source code for the desired application and a new version of the source code for the desired application.

20. A method for generating description text for a desired application using a machine classifier trained using other applications, the method comprising:
utilizing at least one processor to execute computer code that performs the steps of:
obtaining description text and source code for an application;
identifying at least one code characteristic contained within the source code;
associating at least one word expression contained within the description text to at least one identified code characteristic;
identifying, by running the application, at least one screen encountered within the application;
associating at least one word expression contained within the description text to at least one screen;
training the machine classifier, wherein the training comprises identifying similar code characteristics within the source code and identifying, based upon the associating, a condition of the at least one code characteristic including the at least one code characteristic associated word expression and the at least one screen including the at least one screen associated word expression;
obtaining source code for the desired application;
identifying, by running the desired application, at least one screen encountered within the desired application;
identifying, using the trained machine classifier, at least one code characteristic contained within the source code of the desired application and at least one screen of the desired application for use in generating description text for the desired application; and
generating description text for the desired application using the at least one identified code characteristic and the at least one identified screen of the desired application.
